(19) United States
(12) Patent Application Publication
(10) Pub. No.: US 2003/0065759 A1
(43) Pub. Date: Apr. 3, 2003

(54) Event driven storage resource metering

(76) Inventors: Julie Anne Britt, Roseville, CA (US); Simon Derek Hunt, Roseville, CA (US); Dave W. Kasberg, Auburn, CA (US); Anthony R. Silva, Antelope, CA (US); Viswa P. Vutharkar, Roseville, CA (US)

Correspondence Address: HEWLETT-PACKARD COMPANY, Intellectual Property Administration, P. O. Box 272400, Fort Collins, CO, 80527-2400, US

(21) Appl. No.: 09/969,251

(22) Filed: Oct. 1, 2001

(51) Int. Cl. G06F 15/173; G06F 15/16

(52) U.S. Cl. 709/223

(57) ABSTRACT

A management system monitors the storage system for changes in predefined attributes and issues event messages upon detection. A storage collector communicating with the management system responds to the event messages by selectively filtering those pertinent to the billing function. The storage collector generates usage event records that are then further processed by accessing the management system to ascertain if there are any related data objects associated with the object that gave rise to the attribute change. Such additional information is then associated with the usage event and stored for later use by a billing application.

### BACKGROUND OF THE INVENTION

The present invention relates generally to information resource monitoring, and more particularly to resource metering in information storage systems.

In a complex storage system, such as a storage area network (SAN) system, it is often considered desirable to intelligently distribute data across different types of storage media to improve access performance and reduce storage costs. Storage management software systems are frequently used for this purpose. Such storage management systems may perform various data management and storage area management functions, including application management, resource availability management, network management, performance management, service management, systems management, and the like.

In addition to the above data management and storage area management functions, some system users also require storage accountant functionality. Large enterprise systems and service providers frequently want to measure or meter the storage assigned to end users, for financial analysis, budgeting and chargeback. Some storage providers will classify their offerings into different service levels and will manage information related to those service levels. A storage billing application or function allows the storage providers to analyze and recover costs associated with providing storage services.

The challenge with providing such storage billing functionality lies in the diversity of possible storage system configurations and in the diversity of possible factors that a particular system administrator may wish to monitor. For example, a system administrator may wish to calculate usage charges based on input/output and file system usage. The administrator may wish to calculate cost by network domain, by host, by storage device, or by some other physical or logical aspect. The administrator may wish to allow special pricing rules and may need to make billing adjustments in real time.

In addition to the foregoing, some storage systems may be designed to provide different service levels at different pricing. For example, the “economy” service level might provide information storage and retrieval with daily tape backup and help desk support during normal business hours. The “standard” service level might augment the economy level by implementing a RAID0 redundant disk system with 24 hours per day, seven days per week help desk support. The “premium” service level might augment the standard level by adding mirroring to all disk drive systems and increasing the redundancy to RAID5. These different service levels would be charged at different rates and would typically be associated with different storage resources, such as logical units (LUN) within a storage device.

The storage billing application would need to discover usage of these logical units and extract the pertinent attributes by which billing may be effected. Typical attributes of a storage resource include storage ownership, storage size, storage service level (cost) and storage availability. Typically the combination of storage size and service level cost (in terms of cost/size/hour) determines the storage resource cost.

### SUMMARY OF THE INVENTION

The present invention provides a storage billing system and method by which the pertinent attributes associated with storage resources within a storage device are monitored, evaluated and processed to provide metering information from which billing and other management reporting functions can be effected. The system of the invention is event driven. It monitors a data store associated with the storage resources and responds to event messages indicating that a database object or some other attribute of the storage system has changed. In response to such an event message, the system is capable of performing two tasks. It filters event messages to exclude extraneous information that is not relevant to the billing function being performed; and it examines the contents of the data store to determine if there are any other objects associated with the object that has changed. Where such associated objects are identified, the system also collects pertinent information about those objects, so that a complete billing record can be generated and stored at the instant the resource is changed shown by the event message.

The second enumerated function, consulting the data store to identify associated objects, takes place immediately upon identification of a relevant changed object. In this way the system is able to collect information about associated objects before their values are changed by actions taken by other users or actions unrelated to the event being monitored.

The resource metering system and method of the invention can be implemented in a non-invasive fashion. It requires no additional hardware or software additions or changes to the storage devices. It works equally well with storage devices from different vendors and readily permits storage resources to be divided into different service levels so that they can be billed or assigned different associated costs.

In the presently preferred embodiment, the system tracks storage resource attributes which include storage ownership (the identity of the party to whom the storage is assigned), the storage size, storage service level (cost) and storage availability. These attributes are merely exemplary of the type of attributes normally used in a storage billing application. The invention is not limited to these attributes. Rather, it is capable of monitoring any attribute of the storage resource and/or storage device.

For a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is a system block diagram of an exemplary storage network illustrating the basic components used in implementing a preferred embodiment of the invention;

FIG. 2 is a block diagram illustrating two exemplary storage devices being accessed by a plurality of customers;

FIG. 3 is a sequenced diagram illustrating the message handling process in accordance with the invention;

FIG. 4 is a data flow diagram of the presently preferred storage collector.

### DETAILED DESCRIPTION OF THE PREFERRED EMBODIMENTS

The following description of the preferred embodiment(s) is merely exemplary in nature and is in no way intended to limit the invention, its application, or uses.

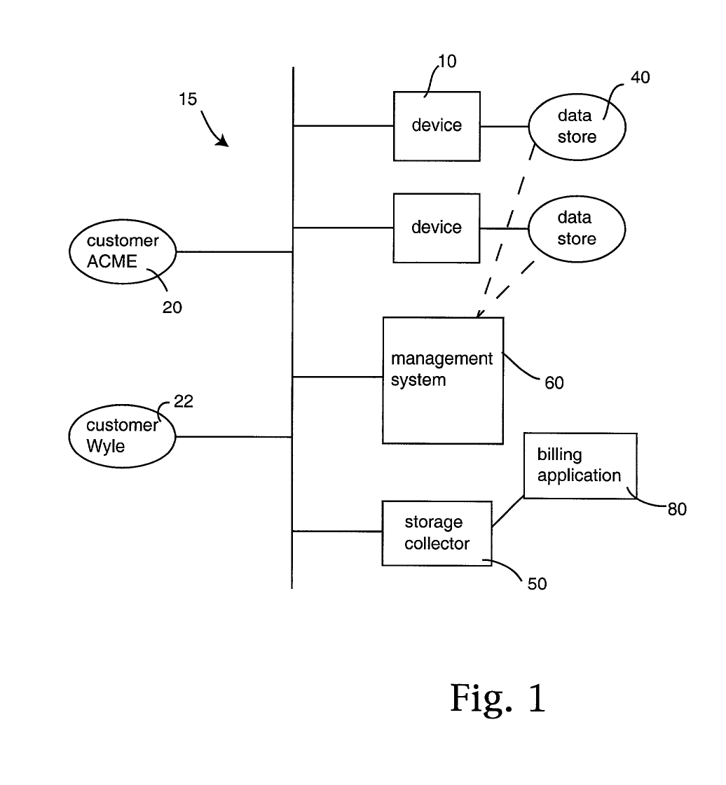

Referring to FIG. 1, an exemplary network is illustrated at 15. It includes a plurality of storage devices, such as devices 10. These devices can be storage area network (SAN) systems or direct attached storage devices. Users or customers, such as customers 20 and 22 access these devices over network 15. The system includes a management system 60 which maintains a data store 40 associated with each device 10. As will be more fully explained below, the data store contains information about various attributes relating to the storage devices and relating to the storage resources defined by those devices.

A storage collector 50 communicates over the network 15 with the management system 60. The storage collector creates and stores usage information until needed by a billing application 80. The storage collector 50 serves as the primary interface between the billing application 80 and the management system 60.

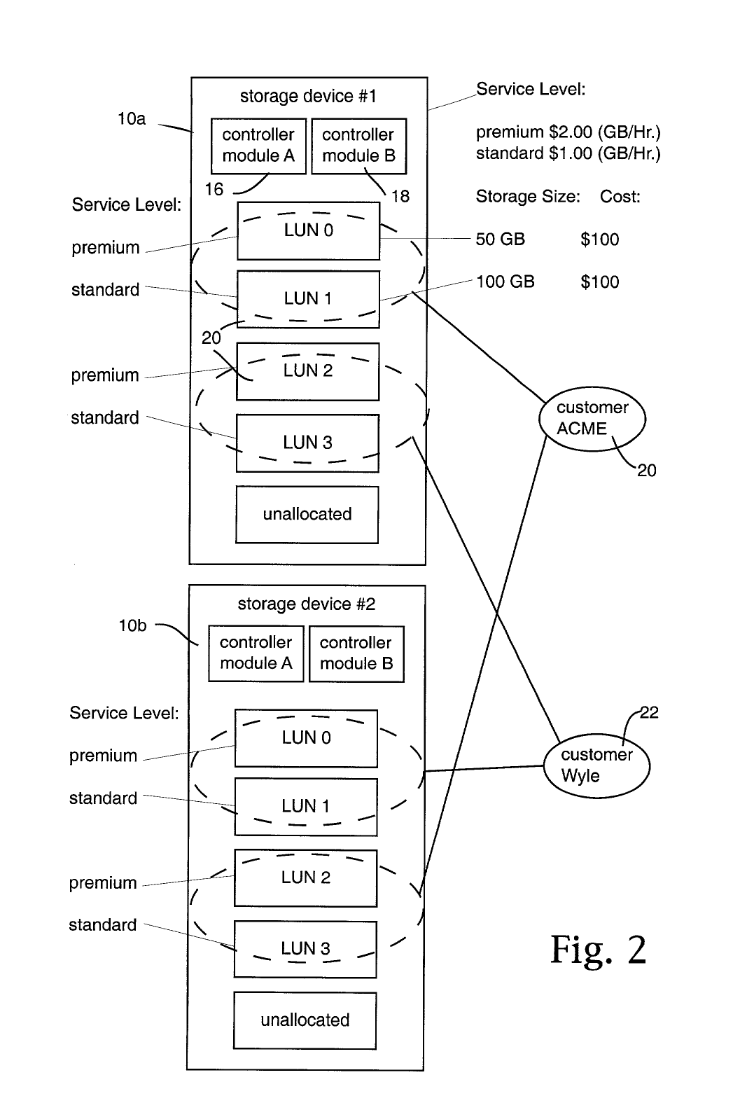

FIG. 2 shows an exemplary billing application in which customers 20 and 22 access different logical units within storage devices 10a and 10b. The logical units, depicted generally by referenced numeral 20, have different service levels (costs) associated with them. Each customer is billed based on a calculation whereby the service level and size of the logical unit are taken into account. While the storage devices 10a and 10b can be of any configuration, they have been illustrated here as storage area network systems, each having a plurality of controller modules 16 and 18.

When attributes of a storage resource changes, the data store 40 (FIG. 1) issues an event message through the management system 60. The management system thus serves as a mediation engine that monitors usage of all devices and outputs information indicative of such use in a common format. In general, the management system can provide data for a variety of different applications, aside from the billing application illustrated here.

The storage collector 50 subscribes to certain usage events and then processes those events as they occur, in order to generate the necessary billing information in real time.

Because an event can issue at any time, the storage collector 50 is designed to respond in asynchronous fashion. The event serves as a trigger which the storage collector then processes to gather the necessary information needed for the billing function.

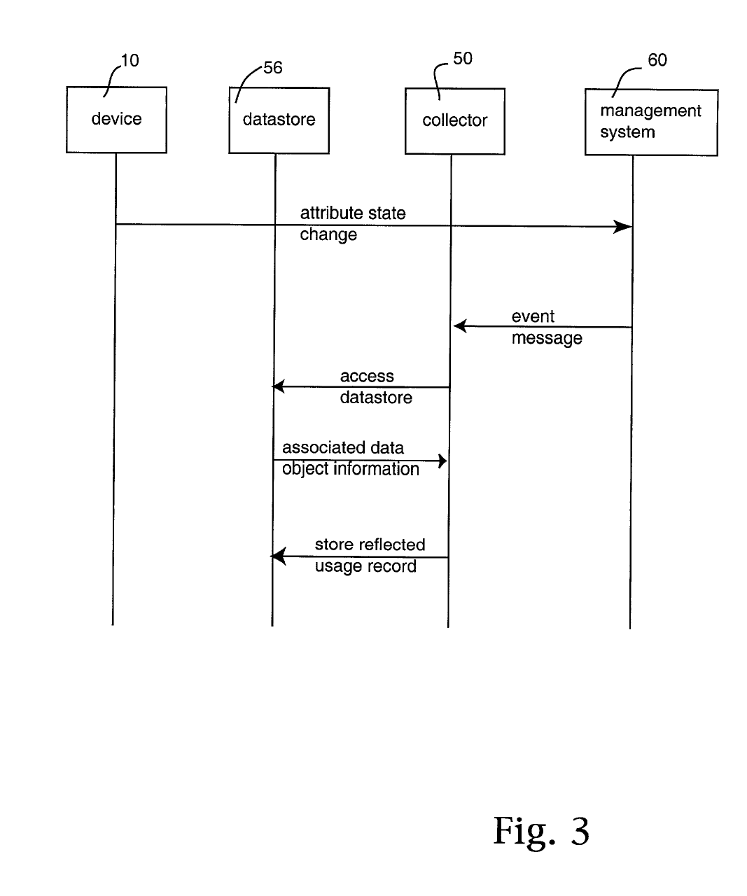

FIG. 3 shows how the presently preferred system operates. When a user accesses a logical unit on a storage device, causing that device to change state with respect to one or more of its attributes, the management system 60 detects this and issues change event messages. The storage collector 50 listens to these event messages and filters them so that only those pertinent to the billing function are acted upon.

Upon receipt of pertinent messages, the storage collector accesses the data store 40 to determine whether there are any related data objects that are important to the billing function. The storage collector gathers these additional pieces of information, even though they may not be directly involved in the change event. This is done to ensure that the snapshots taken by the storage collector of the state of the storage system has all pertinent information needed to perform the billing function. It is important that the storage collector access the database and ascertain the state of associated objects quickly upon having received the initial change event message. This is necessary because the system is designed with multi-user access in mind. Other users may access associated objects and change them without notice. Thus the system is designed to quickly and efficiently acquire the state of associated objects before third parties have the opportunity to change them.

The presently preferred storage collector collects usage events and outputs them to a data store or file system accessible to the billing application.

It is preferably designed to match a particular source and is thus configured with knowledge of a set of relevant attributes for that source. The attributes upon which the billing application will charge a customer must be determined and denoted through external configuration file. In this manner, the storage collector 50 will be able to identify events affecting those attributes as pertinent to the billing or metering system. A time stamp should always be included in a usage event to indicate when a pertinent event took place.

The storage collector 50 runs in an endless loop, creating a new usage record each time a pertinent event is seen. Each usage event is then stored to an external data store or output file for use by the billing system.

The billing application will typically specify that billing is based on ownership of a storage resource.

Illustrated in FIG. 1, the storage collector 50 interfaces with the management system 60 to drive the creation of usage records for storage-related events. The architecture of the invention permits the management system to monitor usage on networks of all sizes. The storage collector can be used, for example, to implement a billing application 80 that tracks attributes of the logical unit on a storage device, such as logical unit 20 of storage device 10. Whenever some attribute of the logical unit is altered, an event will be generated to indicate that billing might have to be adjusted starting at the time of this change. Changed attributes could range from device specific changes, such as a size change, to assignment changes such as a new owner or price.

Interrupted service is also an important concern for billing applications; if a storage resource becomes inaccessible, the user of that resource should not be billed for it. However, because the management system is simply a server on a network, there are several scenarios where the management system might not be able to access the resource, but the owner of the resource can access it. The billing system needs to be able to handle this by allowing a possible credit for the time registered as down.

Information collected in this module is written to a permanent location on a periodic basis. Typically this period will be much shorter than an actual billing cycle to ensure that no data gets lost if a system wide failure occurs and the current period's information is lost. Furthermore, it allows for easier clean up since each group of output records can be deleted without affecting any other records after the information is used by the billing application.

Upon first startup of the storage collector 50, information pertaining to each storage resource currently residing in the database is stored to a permanent output location (file or database) immediately. This allows for a starting point from which changes to each storage resource can be recorded. If the storage collector starts up several times during a billing cycle, extraneous and duplicate information will be saved but it should serve to sync up possibly out of date data rather than allowing out of date or overlapping information.

In the preferred implementation, the storage collector 50 runs continuously. A mechanism is provided for writing and retrieving recovery information. This is used to make sure that the storage collector's information is in a good state to continue collecting events since the last shutdown. Finally, a flushing mechanism is provided by the storage collector 50 to flush the contents of its currently collected event information to a permanent output location. This is used periodically and causes the event information up to this point to be placed in a form retrievable by the billing system.

In the presently preferred embodiment, the storage collector 50, illustrated in FIG. 1, is the primary interface between the billing or metering application and the management system 60. It is responsible for accessing the data store 20 when required and for receiving events generated by any changes in the objects being managed through the data store.

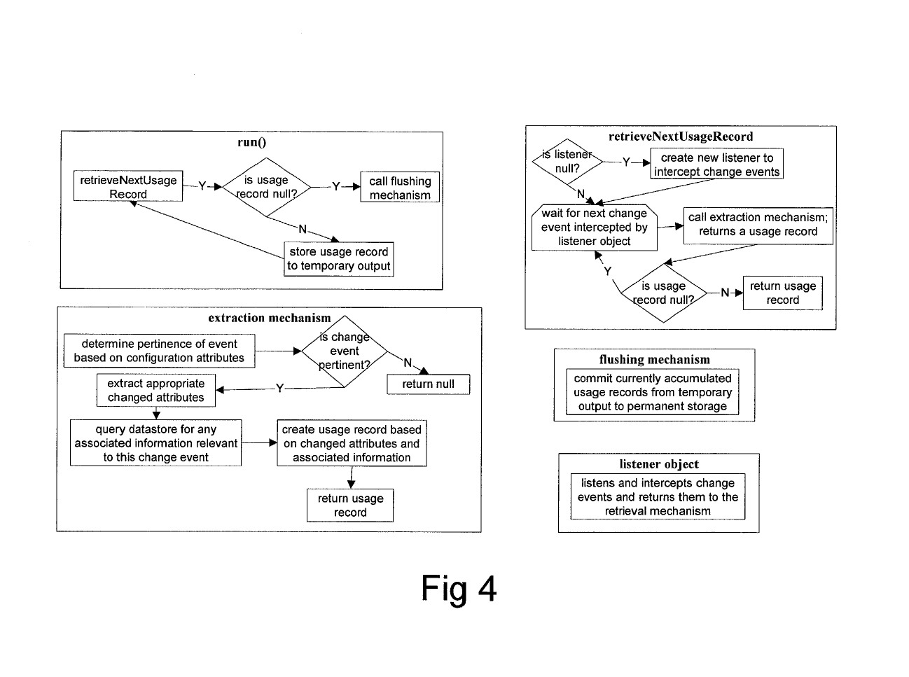

FIG. 4 is a data flow diagram indicating the data flow across the storage collector 50. The storage collector 50 is initially set up by reading information necessary to initialize itself during the configuration process. This would include the attributes upon which the billing system is based to help determine which events are pertinent. It sets up some kind of event listener which initiates the acceptance of change events.

When an event is seen, pertinence to the billing system is determined. Once pertinence is established, an extraction function will pull out the appropriate information needed for the billing system.

Upon returning, the event's complete and appropriate informationis written to a temporary output location, either a file or a temporary data store, until such time as the storage collector's flushing mechanism is invoked. Further processing may be done on the event prior to the storing of the event information, but that is not covered in this invention.

A special startup mode is recommended. If the storage collector 50 is first being entered, it will initially read the state of each storage resource currently known in the database and store an event representing each one. This will allow a starting state from which event-driven changes can be recorded.

A recovery mechanism implemented by the storage collector 50 should only be called upon startup and will clean up any temporary information from prior to the shutdown by initiating the flushing mechanism. This will ensure a valid starting state for further event information. The only other kind of error recovery that could be addressed in here is missing events. However, this invention puts certain conditions on the system that will avoid events being lost; any implementation should ensure that precautions are taken to eliminate the missing of events. This is most important during a period in which the management system was down and storage resource configurations changed. When the management system starts back up again, those changes should be caught and the changed information should be seen as events. Once the system is started, events should occur reliably and there should exist no case in which a database object is added, changed or deleted where the listener isn't notified.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An event-driven resource metering system for use with a storagesystem, comprising:
a management system in communication with said storagesystem;
said management system defining at least one usage attribute relating to said storage system and configured to issue event messages corresponding to a change in said usage attribute;
a storage collector in communication with said management system and configured to respond to selected event messages by creating a record of said event message.

2. The system of claim 1 wherein said storage collector is further configured to respond to said selected event messages by accessing said management system to acquire additional information associated with said change in said usage attribute.

3. The system of claim 1 further comprising a storage network, and wherein said management system communicates with said storage system over said network.

4. The system of claim 1 further comprising a storage network, and wherein said storage collector communicates with said management system over said network.

5. The system of claim 1 wherein said storage collector comprises asynchronous communication with said management system by continuously listening for event messages and generating usage record information in response to an event message.

6. The system of claim 1 wherein said storage collector is configured to generate and store a plurality of records of event messages; and wherein the system further comprises,
a billing application in communication with said storage collector and configured to generate usage report information based on said plurality of records.

7. The system of claim 1 wherein said storage system is arranged into storage resources having different associated usage costs and wherein the system further comprises,
a billing application in communication with said storage collector that associates said usage costs with said record of event message.

8. A method of metering storage system resource usage, comprising:
listening for said event messages and creating a usage record upon receipt; and
processing said usage record by accessing said management system to acquire additional information associated with said attribute change.

9. The method of claim 10 further comprising filtering said event messages based on a predefined set of rules.

10. The method of claim 10 further comprising collecting and storing a plurality of usage records and accessing said stored usage records.

11. The method of claim 10 wherein said storage system is organized into storage resources having associated usage costs and wherein said method further comprises associating a usage cost with said usage record.

12. The method of claim 10 wherein said listening step is performed by running a storage collector that generates a usage record upon receipt of change event messages.

13. The method of claim 10 wherein said processing step is performed by identifying at least one database object associated with said changed attribute and accessing said management system to acquire information about additional database objects in a database relationship with said one database object.
